(19) United States
(12) Patent Application Publication
(10) Pub. No.: US 2003/0217611 A1
(43) Pub. Date: Nov. 27, 2003

(54) Ball screw device

(75) Inventors: Masato Kato, Gunma (JP); Shigeru Okita, Gunma (JP); Yasumi Watanabe, Gunma (JP)

Correspondence Address: SUGHRUE MION, PLLC, 2100 PENNSYLVANIA AVENUE, N.W., WASHINGTON, DC, 20037, US

(73) Assignee: NSK LTD.

(21) Appl. No.: 10/391,188

(22) Filed: Mar. 19, 2003

(30) Foreign Application Priority Data
Mar. 19, 2002 (JP) P. 2002-077122

(51) Int. Cl. F16H 1/24

(52) U.S. Cl. 74/424.71

(57) ABSTRACT

A ball screw device has a screw shaft having a helical thread groove provided on an outer surface thereof; a ball nut having a thread groove provided on an inner surface thereof, the ball nut being movably fitted on the screw shaft; a number of balls rollably interposed between the two thread grooves; and a ball circulating member fixed to the ball nut for forming a ball circulation path through which the balls rolling on a gap between the two thread grooves are endlessly circulated, wherein the ball has a distribution of residual compressive stress including a maximum value σₛ of 1,000 MPa or less after polishing in a production process involving surface hardening followed by hardening and tempering and the residual compressive stress σ_{D} at the depth of 1% of the ball diameter Dw from the surface of the ball is the maximum value σₛ or less.

### BACKGROUND OF THE INVENTION

1. Field of the Invention

The present invention relates to a ball screw device for use in the feed mechanism, etc. of various apparatus which are operated with a great lead at a high speed and a high acceleration and deceleration and more particularly to a ball screw device suitable for use in environments subject to high load.

2. Description of the Related Art

As such a related art ball screw device there is known one shown in FIG. 4. This ball screw device 1 comprises a screw shaft 3 having a helical thread groove 2 provided on the outer surface thereof and extending in the axial direction and a ball nut 6 having a helical thread groove 4 provided on the inner surface thereof movably fitted thereon.

The thread groove 4 of the ball nut 6 and the thread groove 2 of the screw shaft 3 are opposed to each other to form a helical path therebetween. A number of balls 5 are rollably disposed on the helical path as rolling elements. In this arrangement, when the screw shaft 3 rotates, the ball nut 6 makes linear movement via rolling of the balls 5.

When the ball nut 6 makes linear movement, the balls 5 roll over through the helical path formed by the thread grooves 2, 4. In order to allow the ball nut 6 to move continuously, it is necessary that the balls 5 be endlessly circulated.

To this end, the outer surface of the ball nut 6 is partly formed flat. Two sets of holes 51 communicating to the thread grooves 2, 4, respectively, are formed at the respective side of the screw shaft 3. A U-shaped ball tube 50A which is a ball circulating member is inserted in the two sets of holes 51 at the both ends thereof to form a ball circulation path 52. In order to form this ball circulation path, a shuttle type, endcap type or any other type ball circulating member may be used besides the ball tube type ball circulating member.

At present, the cleanness of coil materials used for ball of ball screw device has been gradually enhanced to raise reliability. However, non-metallic inclusions in steel cannot be completely removed. Thus, ball screw devices can undergo early breakage of ball due to these non-metallic inclusions during high speed operation.

As a technique for prolonging the life of ball, JP-B-1-12812 discloses a technique which comprises subjecting ball to hardening and tempering followed by mechanical surface hardening by air spray peening to cause plastic deformation on the surface layer thereof and hence enhance hardness, thereby providing the surface of the ball with a high residual compressive stress layer to prolong the fatigue life of the ball and lessen the occurrence of surface scratch during handling.

However, the technique of JP-B-1-12812 is disadvantageous in that since the ball has been already subjected to a kind of plastic forming corresponding to contact fatigue such as mechanical surface hardening by air spray peening, the resulting ball is under high residual stress before the operation of ball screw device.

Further, when the balls collide with each other in a ball screw device during high speed operation or when the balls hit the ball catching portion of the ball tube or the screw shaft or ball nut during the beginning of loading in a tube type ball screw device, the residual stress in the interior of the ball is acceleratedly, occasionally causing early exfoliation of ball due to non-metallic inclusions, etc.

### SUMMARY OF THE INVENTION

The present invention has been worked out to eliminate these disadvantages. An aim of the present invention is to provide a ball screw device which can be protected against early exfoliation of ball to prolong its life even when used in environments subject to high load.

In order to accomplish the aforementioned aim, the present invention according to a first aspect lies in a ball screw device having a screw shaft having a helical thread groove provided on an outer surface thereof; a ball nut having a thread groove corresponding to the thread groove of the screw shaft provided on an inner surface thereof, the ball nut being movably fitted on the screw shaft; a number of balls rollably interposed between the two thread grooves; and a ball circulating member fixed to the ball nut for forming a ball circulation path through which the balls rolling on a gap between the two thread grooves are endlessly circulated, wherein the ball has a distribution of residual compressive stress including a maximum value σₛ of 1,000 MPa or less after polishing in a production process involving surface hardening followed by hardening and tempering and the residual compressive stress σ_{D} at the depth of 1% of the ball diameter Dw from the surface of the ball is the maximum value σₛ or less.

The present invention according to a second aspect lies in the ball screw device as described in the first aspect, wherein a spacer made of resin is interposed between the number of balls rollably disposed between the two thread grooves.

The present invention according to a third aspect lies in the ball screw device as described in the first or second aspect, wherein the distribution of residual compressive stress including a maximum value σₛ of 800 MPa or less

### BRIEF DESCRIPTION OF THE DRAWINGS

FIG. 1 is a sectional view of essential part illustrating a ball screw device which is an embodiment of implementation of the present invention;

FIG. 2 is a graph illustrating the relationship between the ball exfoliation life ratio and the residual stress σ_{D} of the surface layer of ball;

FIG. 3 is a graph illustrating the relationship between the ball exfoliation life ratio shown when the residual stress σ_{D} of the surface layer of ball is 800 MPa and the rotational speed of the ball screw device; and

FIG. 4 is a partly cutaway perspective view illustrating a related art ball screw device.

### DETAILED DESCRIPTION OF THE PREFERRED EMBODIMENTS

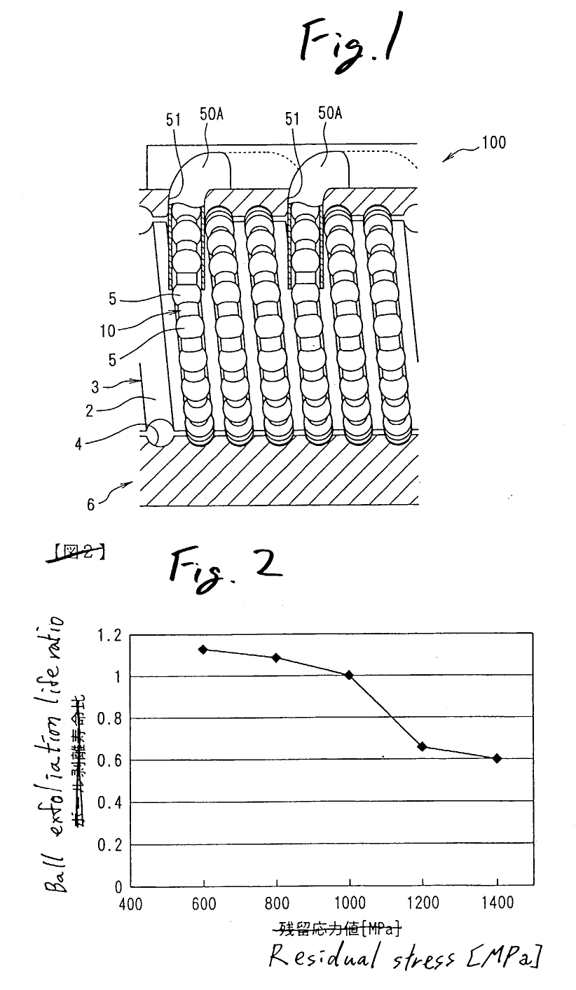

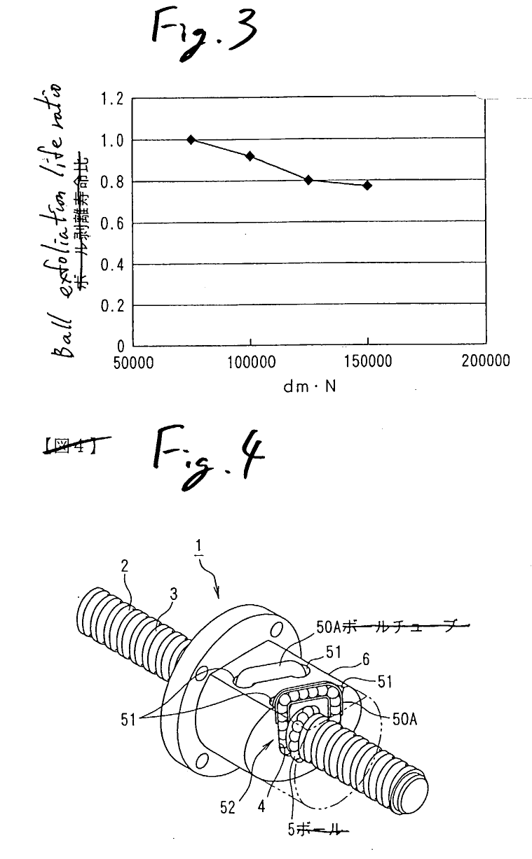

An embodiment of implementation of the present invention will be described hereinafter in connection with the attached drawings. FIG. 1 is a sectional view of essential part illustrating a ball screw device which is an embodiment of implementation of the present invention, FIG. 2 is a graph illustrating the relationship between the ball exfoliation life ratio and the residual stress σ_{D} of the surface layer of ball, and FIG. 3 is a graph illustrating the relationship between the ball exfoliation life ratio shown when the residual stress σ_{D} of the surface layer of ball is 800 MPa and the rotational speed of the ball screw device. In this embodiment, like numerals are used and description is omitted where the parts are the same as those of FIG. 4.

The ball screw device 100 comprises a spacer 10 made of resin interposed between a number of balls 5 rollably disposed on a helical path formed by a thread groove 4 on a ball nut 6 and a thread groove 2 on a screw shaft 3 as shown in FIG. 1. The spacer 10 is in the form of cylinder or column the both axial ends of which have a concave form that follows the shape of the ball 5.

In the present embodiment, as the ball 5 there is used a ball has a distribution of residual compressive stress including a maximum value σₛ of 1,000 MPa or less preferably not greater than 800 MPa, after polishing in a production process involving surface hardening followed by hardening and tempering, and the residual compressive stress σ_{D} at the depth of 1% of the ball diameter Dw from the surface of the ball is not greater than the maximum value σₛ.

Thus, the reduction of the final residual stress σ_{D} Of the surface layer of ball during the production of the ball 5 and the disposition of the spacer 10 made of resin interposed between the balls 5 of the ball screw device 100 make it possible to eliminate collision of the balls 5 with each other under no load. Further, the collision of the balls 5 with the ball catching portion of a ball tube 50A or the screw shaft 3 and the ball nut 6 (when the ball screw device begins to get under load) can be relaxed jointly by the final residual stress of the surface layer of the ball and the elastic force of the spacer 10 made of resin. As a result, the early exfoliation of the ball 5 can be prevented even when used in environments subject to high load, making it possible to realize a ball screw device which can be operated with a low noise and a great lead at a high speed and a high acceleration and deceleration free from early exfoliation during use under high load conditions for a prolonged life.

The structure of the ball screw device, the ball circulating member, the spacer, etc. of the present invention are not limited to the aforementioned embodiment and proper modifications can be made therein so far as they don't depart from the scope of the present invention.

For example, the aforementioned embodiment has been described with reference to the case where the present invention is applied to a ball screw device comprising a ball tube as a ball cyclic member, but the present invention is not limited thereto. It goes without saying that the present invention can be applied to a ball screw device comprising a shuttle type, endcap type or any other type ball cyclic member.

While the aforementioned embodiment has been described with reference to the case where a spacer 10 made of resin is interposed between the balls 5, it is not necessarily required that this arrangement be employed. The predetermination of the final residual stress σ_{D} of the surface layer of ball to not greater than 1,000 MPa, preferably not greater than 800 MPa makes it possible to relax the collision of the balls 5 with each other under no load or the collision of the balls 5 with the ball catching portion of the ball tube 50A or the screw shaft 3 or the ball nut 6 (when the ball screw device begins to get under load) and hence prevent early exfoliation of the balls 5 in environments subject to high load.

### EXAMPLE

In order to confirm the effect of the present invention, exfoliation life test was made on the ball of a ball screw device during use under a high load.

As ball screw devices to be tested there were prepared five kinds of ball screw device with a nominal count of Ball Screw 25×25×900-CS (ball diameter: 3/16 inch; spacer made of resin interposed between balls) produced by NSK Ltd. having a ball surface layer residual stress σ_{D} of 600 MPa, 800 MPa, 1,000 MPa, 1,200 MPa and 1,400 MPa, respectively. As a testing machine there was used a ball screw durability life testing machine produced by NSK Ltd. The lifetime at which the number of the resulting ball exfoliation (damage) reaches 10% of the number of the balls was then determined under the following conditions.

Testing Conditions:

Pre-load: 500 N

Testing load: Axial load=2,000 N

Acceleration load=500 to 1,000 N

Rotational speed: 3,000 min⁻¹

Stroke: 300 mm

Lubricating grease: Albania No. 2 (Showa Shell Sekiyu K.K.)

The results are set forth in FIG. 2. In FIG. 2, the ball exfoliation life is represented relative to that of the test ball screw having a residual stress σ_{D} of 1,000 MPa, which is the center value, of those of the five kinds of the test ball screws, as 1.

As can be seen in the drawing, under high speed conditions, the ball exfoliation life shows a sudden drop at a maximum residual compressive stress σ_{D} of not smaller than 1,200 MPa, which exceeds 1,000 MPa. As can be seen in these data, in order to inhibit early ball exfoliation occurring during high speed operation, it is preferred that a ball having a maximum residual compressive stress σ_{D} of not greater than 1,000 MPa, preferably not greater than 800 MPa be used for ball screw devices.

FIG. 3 illustrates the relationship between the ball exfoliation life ratio shown when the residual stress σ_{D} of the ball is 800 MPa and dm·N of the ball screw device. In FIG. 3, the ball exfoliation life is 1 when dm·N is 75,000. When dm·N is not greater than 50,000, no early ball exfoliation occurs. Thus, the usefulness of the present invention is definitely exhibited during high speed operation.

As can be seen in the aforementioned description, in accordance with the present invention of the first aspect, the collision of the balls with each other under no load or the collision of the balls with the ball catching portion or the screw shaft or ball nut (when the ball screw device begins to get under load) can be relaxed, making it possible to realize a ball screw device which can be operated with a low noise and a great lead at a high speed and a high acceleration and deceleration free from early exfoliation during use under high load conditions for a prolonged life.

In accordance with the present invention of the second aspect, in addition to the present invention of the first aspect, the collision of the balls with each other under no load can be eliminated and the collision of the balls with the ball catching portion or the screw shaft or ball nut (when the ball screw device begins to get under load) can be relaxed jointly by the properties of the balls and the elastic force of the spacer made of resin, making it possible to further prolong the life of the ball screw device and reduce the noise.

What is claimed is:

1. A ball screw device comprising:
a screw shaft having a helical thread groove provided on an outer surface thereof;
a ball nut having a thread groove corresponding to the thread groove of the screw shaft provided on an inner surface thereof, the ball nut being movably fitted on the screw shaft;
a number of balls rollably interposed between the two thread grooves; and
a ball circulating member fixed to the ball nut for forming a ball circulation path through which the balls rolling on a gap between the two thread grooves are endlessly circulated,
wherein the ball has a distribution of residual compressive stress including a maximum value σₛ of 1,000 MPa or less after polishing in a production process involving surface hardening followed by hardening and tempering, and the residual compressive stress σ_{D} at the depth of 1% of the ball diameter Dw from the surface of the ball is the maximum value σₛ or less.

2. The ball screw device according to claim 1, wherein a spacer made of resin is interposed between the number of balls rollably disposed between the two thread grooves.

3. The ball screw device according to claim 1, wherein the distribution of residual compressive stress including a maximum value σₛ of 800 MPa or less

4. The ball screw device according to claim 2, wherein the distribution of residual compressive stress including a maximum value σₛ of 800 MPa or less
